(19) United States
(12) Patent Application Publication
(10) Pub. No.: US 2010/0127230 A1
(43) Pub. Date: May 27, 2010

(54) Puller Device

(76) Inventor: Jung-Liang Hung, Minsyong Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/277,353

(22) Filed: Nov. 25, 2008

(51) Int. Cl. B66F 3/26

(52) U.S. Cl. 254/93 R

(57) ABSTRACT

A puller device comprises a support set disposed on one end of a base for moving the puller device vertically and connected with a cylinder, a hydraulic pump mounted on one end of the cylinder; an adjusting assembly fixed on the action end of the support set for adjustably tilting the pulling assembly and including a fixed member secured proximate to the lower end thereof and pivotally coupled with a movable member attached on the upper end of the adjusting assembly, and first and second fastening parts extendedly arranged on the fixed and movable members respectively for inserting through a micro-adjusting post so as to adjustably move the pulling assembly vertically; a pulling assembly assembled on one end of the adjusting assembly for dissembling the large-size workpiece and including a cylinder disposed on one end thereof for driving a hook set to expand or retract to pull the workpiece.

### BACKGROUND OF THE INVENTION

1. Field of the Invention

The present invention relates to a puller device that allows to disassemble large-size mechanical components by moving the puller device vertically and adjusting the angle of the puller device.

2. Description of the Prior Arts

Conventional puller devices are used to assemble or disassemble large-size mechanical components, e.g., bearings, gears, tubular members, and the like. Generally, the puller device is driven by a hydraulic pump to move a hook set vertically, and then a cylinder further drives the hook set to assemble or disassemble the workpiece.

The present invention has arisen to mitigate and/or obviate the afore-described disadvantages.

### SUMMARY OF THE INVENTION

The primary objective of the present invention is to provide a puller device, which allows to disassemble large-size mechanical components by moving the puller device vertically and adjusting the angle of the puller device.

The puller device comprises a support set, an adjusting assembly for adjusting the angle of the puller device, and a pulling assembly, wherein

the support set is disposed on one end of a base for moving the puller device vertically and is connected with a cylinder, and a hydraulic pump mounted on one end of the cylinder is used to drive the puller device to move vertically;

the adjusting assembly is fixed on the action end of the support set for adjustably tilting the pulling assembly and includes a fixed member secured proximate to the lower end thereof and pivotally coupled with a movable member which is attached on the upper end of the adjusting assembly, and first and second fastening parts are extendedly arranged on the fixed and movable members respectively for inserting through a micro-adjusting post so as to adjustably move the pulling assembly vertically;

the pulling assembly is assembled on one end of the adjusting assembly for dissembling the large-size workpiece and includes a cylinder disposed on one end thereof for driving a hook set to expand or retract to pull the workpiece.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view illustrating the assembly of a puller device according to the present invention;

FIG. 2 is a side plan view illustrating the assembly of the puller device according to the present invention;

FIG. 3 is a side plan view illustrating a support set of the puller device of the present invention moving upward;

FIG. 4 is a side plan view illustrating a pulling assembly of the puller device of the present invention moving upward and obliquely;

FIG. 5 is a side plan view illustrating the pulling assembly of the puller device of the present invention moving downward and obliquely;

FIG. 6 is a perspective view illustrating a hook set of the puller device of the present invention being driven to expand outward;

FIG. 7 is a side plan view illustrating the hook set of the puller device of the present invention expanding to clamp and pull a workpiece;

FIG. 8 is anther side plan view illustrating the hook set of the puller device of the present invention expanding to clamp and pull the workpiece.

### DETAILED DESCRIPTION OF THE PREFERRED EMBODIMENT

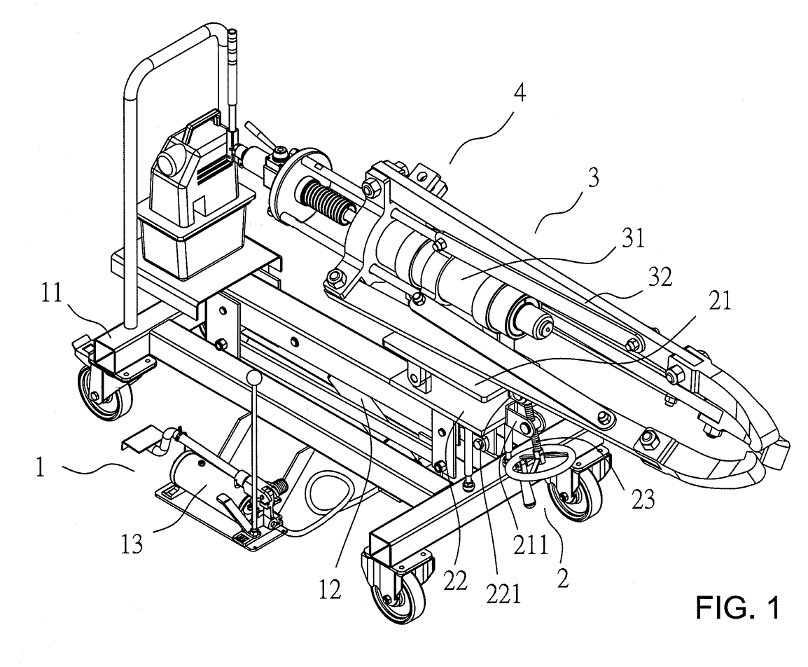

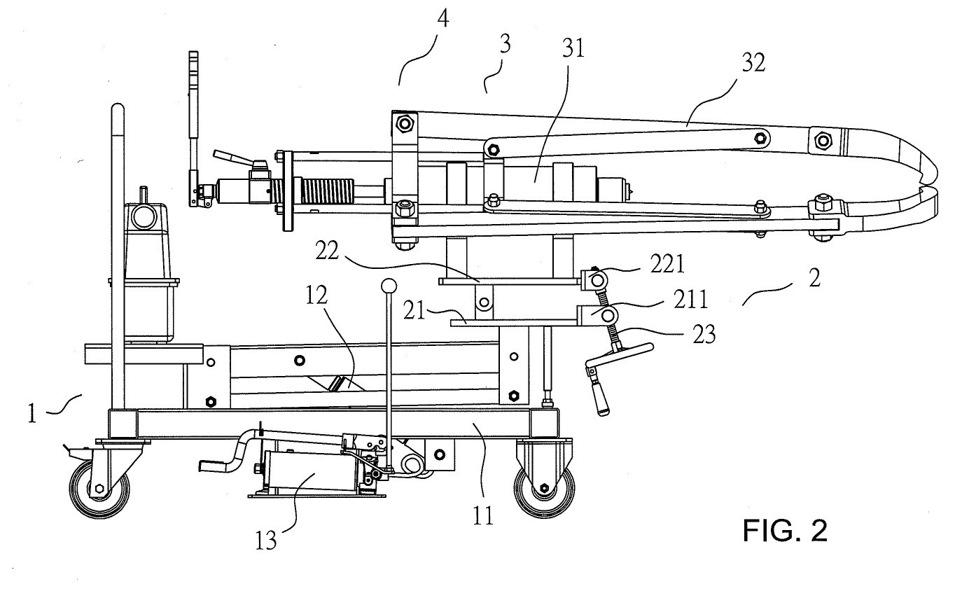

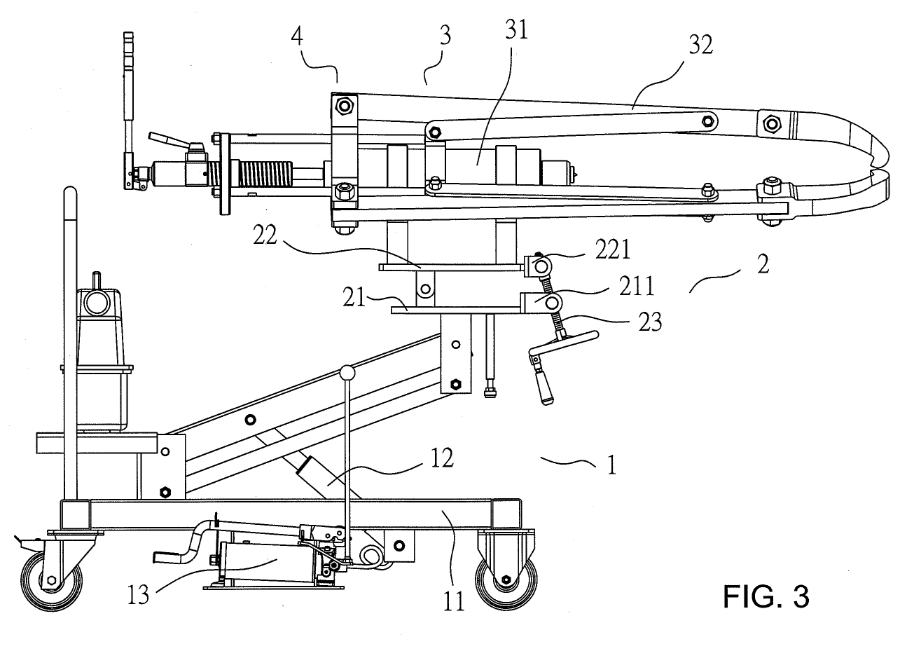

Referring to FIGS. 1 and 2, a puller device 4 in accordance with the present invention is used to disassemble large-size mechanical components, e.g., bearings, gears, tubular members and comprises a support set 1, an adjusting assembly 2 for adjusting the angle of the puller device 4, and a pulling assembly 3, wherein the support set 1 is disposed on one end of a base 11 for moving the puller device 4 vertically and is connected with a cylinder 12, and a hydraulic pump 13 mounted on one end of the cylinder 12 is used to drive the puller device 4 to move vertically (as illustrated in FIGS. 2 and 3);

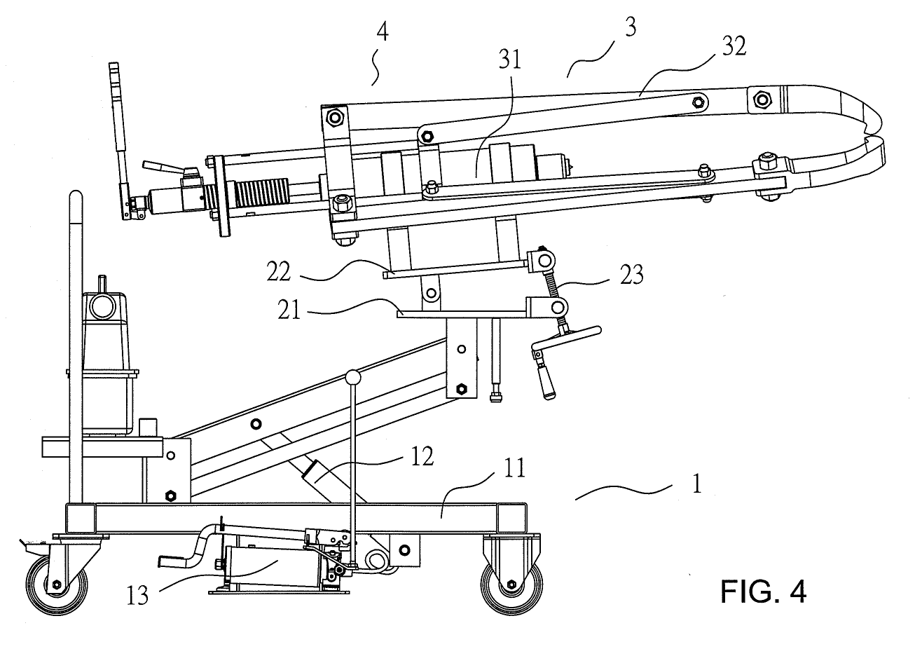

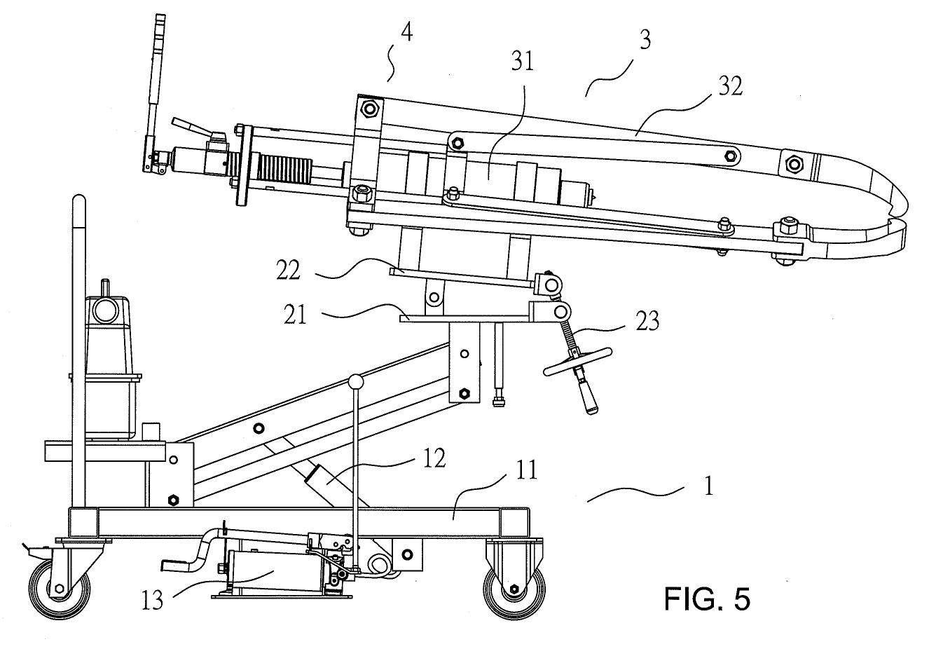

the adjusting assembly 2 is fixed on the action end of the support set 1 for adjustably tilting the pulling assembly 3 and includes a fixed member 21 secured proximate to the lower end thereof and pivotally coupled with a movable member 22 which is attached on the upper end of the adjusting assembly 2, and first and second fastening parts 211, 221 are extendedly arranged on the fixed and movable members 21, 22 respectively for inserting through a micro-adjusting post 23 (as shown in FIG. 1) so as to adjustably move the pulling assembly 3 vertically (as illustrated in FIGS. 4 and 5);

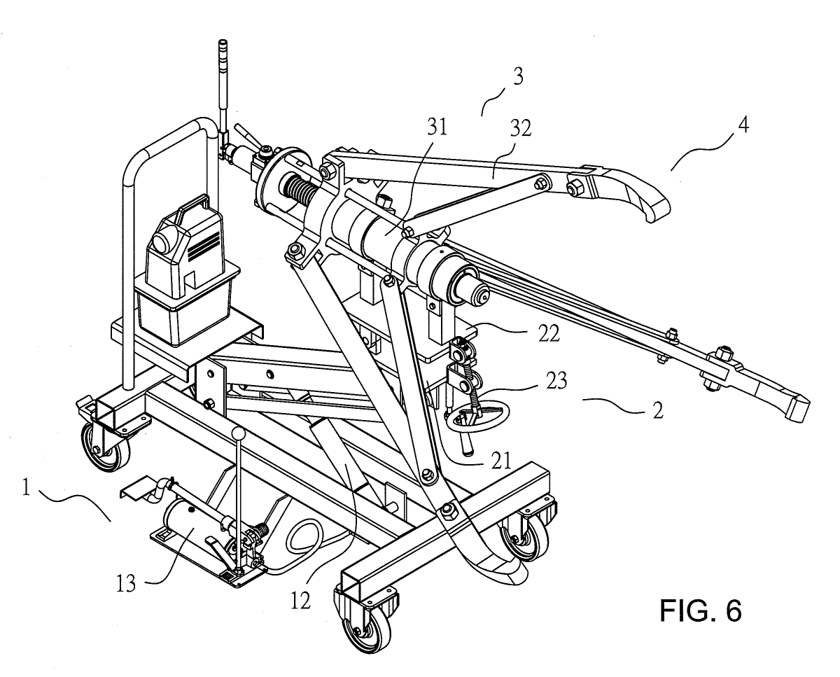

the pulling assembly 3 is assembled on one end of the adjusting assembly 2 for dissembling the large-size workpiece and includes a cylinder 31 disposed on one end thereof for driving a hook set 32 to expand or retract to pull the workpiece (as shown in FIGS. 1 and 6).

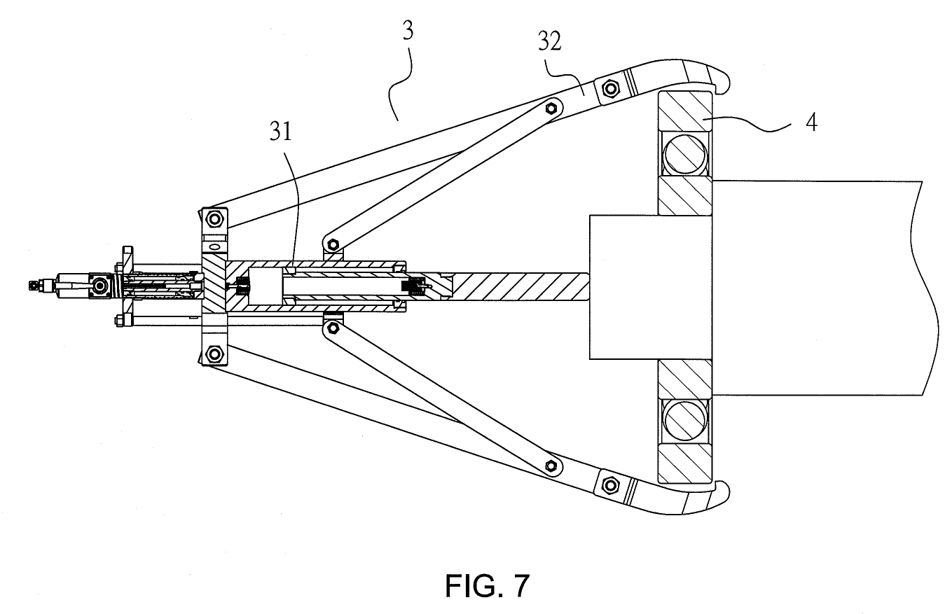

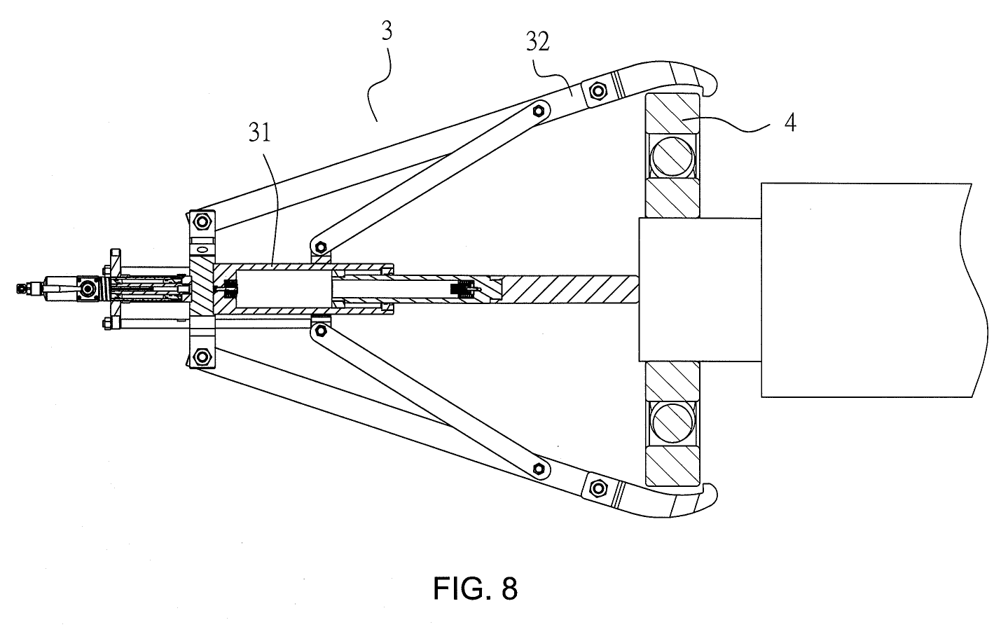

As illustrated in FIG. 6, during disassembling a large-size workpiece, the hydraulic pump 13 drives the cylinder 12 to move the support set 1 upward to a desired height, and the micro-adjusting post 23 of the adjusting assembly 2 adjustably rotates the pulling assembly 3 to a suitable angle (as illustrated in FIGS. 4 and 5). Furthermore, the cylinder 31 disposed on one end of the pulling assembly 3 drives the hook set 32 to expand (as illustrated in FIG. 7) to clamp and pull a workpiece 5 outward (as shown in FIG. 8). After the disassembly of the workpiece 5, the cylinder 31 drives the hook set 32 to retract (as illustrated in FIG. 1), thus finishing the disassembly of the workpiece.

While we have shown and described various embodiments in accordance with the present invention, it should be clear to those skilled in the art that further embodiments may be made without departing from the scope of the present invention.

What is claimed is:

1. A puller device comprising:
a support set, an adjusting assembly for adjusting the angle of the puller device, and a pulling assembly, wherein
the support set is disposed on one end of a base for moving the puller device vertically and is connected with a cylinder, and a hydraulic pump mounted on one end of the cylinder is used to drive the puller device to move vertically;
the adjusting assembly is fixed on the action end of the support set for adjustably tilting the pulling assembly and includes a fixed member secured proximate to the lower end thereof and pivotally coupled with a movable member which is attached on the upper end of the adjusting assembly, and first and second fastening parts are extendedly arranged on the fixed and movable members respectively for inserting through a micro-adjusting post so as to adjustably move the pulling assembly vertically;
the pulling assembly is assembled on one end of the adjusting assembly for dissembling the large-size workpiece and includes a cylinder disposed on one end thereof for driving a hook set to expand or retract to pull the workpiece.
